(19) United States
(12) Patent Application Publication
(10) Pub. No.: US 2026/0288389 A1
(43) Pub. Date: Sep. 24, 2026

(54) NON-TRANSITORY COMPUTER-READABLE STORAGE MEDIUM STORING PRINTING CONTROL PROGRAM, INFORMATION PROCESSING APPARATUS, AND CONTROL METHOD

(71) Applicant: SEIKO EPSON CORPORATION, Tokyo (JP)

(72) Inventors: Masato FURUSE, Okaya (JP); Tomoki MATSUZAWA, Shiojiri (JP)

(21) Appl. No.: 19/574,565

(22) Filed: Mar. 23, 2026

(30) Foreign Application Priority Data
Mar. 24, 2025 (JP) 2025-048426

(51) Int. Cl. G06F 3/12

(52) U.S. Cl. CPC G06F 3/1228; G06F 3/1205; G06F 3/1225; G06F 3/1259

(57) ABSTRACT

A non-transitory computer-readable storage medium storing a printing control program according to the present disclosure is a non-transitory computer-readable storage medium storing a printing control program that extends a general-purpose printer driver, in which the printing control program causes a computer to execute first reception processing of receiving print data from a first application, first update processing of enabling a flag indicating that a printer is in communication in response to the reception in the first reception processing, first transmission processing of transmitting the received print data to the printer, second reception processing of receiving a communication request to the printer from a second application, and prohibition processing of prohibiting, when the flag is enabled, the communication with the printer in response to the communication request from the second application.

The present application is based on, and claims priority from JP Application Serial Number 2025-048426, filed Mar. 24, 2025, the disclosure of which is hereby incorporated by reference herein in its entirety.

### BACKGROUND

### 1. Technical Field

The present disclosure relates to a non-transitory computer-readable storage medium storing a printing control program, an information processing apparatus, and a control method.

### 2. Related Art

Until now, when an information processing apparatus transmits print data to a printer, a printer driver supplied by a vendor, who provides the printer, is generally used. However, in recent years, instead of such a driver, a general-purpose printer driver such as an operating system (OS) standard printer driver is used, as disclosed in JP-A-2021-108000.

Incidentally, an application communicating with the printer via the general-purpose printer driver and an application communicating with the printer without going through the general-purpose printer driver may be installed in the information processing apparatus. In this case, when these two applications communicate with the same printer at the same time, a collision in communication may occur, and thus the application or the printer may not operate normally.

### SUMMARY

According to an aspect of the present disclosure, there is provided a non-transitory computer-readable storage medium storing a printing control program that extends a general-purpose printer driver, the printing control program causing a computer to execute first reception processing of receiving print data from a first application, first update processing of enabling a flag indicating that a printer is in communication in response to the reception in the first reception processing, first transmission processing of transmitting the received print data to the printer, second reception processing of receiving a communication request to the printer from a second application, and prohibition processing of prohibiting, when the flag is enabled, the communication with the printer in response to the communication request from the second application, in which the first application is any one of an application using the general-purpose printer driver and an application not using the general-purpose printer driver, and the second application is another one of the application using the general-purpose printer driver and the application not using the general-purpose printer driver.

According to another aspect of the present disclosure, there is provided an information processing apparatus that includes a general-purpose printer driver and a printing control program extending the general-purpose printer driver, the information processing apparatus including, as functions of the printing control program, a first communication-request reception section that receives print data from a first application, an update processing section that enables a flag indicating that a printer is in communication in response to the reception in the first communication-request reception section, a communication execution section that transmits the received print data to the printer, a second communication-request reception section that receives a communication request to the printer from a second application, and a communication control section that prohibits, when the flag is enabled, the communication with the printer in response to the communication request from the second application, in which the first application is any one of an application using the general-purpose printer driver and an application not using the general-purpose printer driver, and the second application is another one of the application using the general-purpose printer driver and the application not using the general-purpose printer driver.

According to still another aspect of the present disclosure, there is provided a control method executing, by a computer that includes a general-purpose printer driver and a printing control program extending the general-purpose printer driver, the printing control program to execute first reception processing of receiving print data from a first application, first update processing of enabling a flag indicating that a printer is in communication in response to the reception in the first reception processing, first transmission processing of transmitting the received print data to the printer, second reception processing of receiving a communication request to the printer from a second application, and prohibition processing of prohibiting, when the flag is enabled, the communication with the printer in response to the communication request from the second application, in which the first application is any one of an application using the general-purpose printer driver and an application not using the general-purpose printer driver, and the second application is another one of the application using the general-purpose printer driver and the application not using the general-purpose printer driver.

### BRIEF DESCRIPTION OF THE DRAWINGS

FIG. 1 is a block diagram showing a configuration example of a printing system according to an embodiment.

FIG. 2 is a block diagram showing components of an information processing apparatus according to Embodiment 1, which are provided as functions of a printing control program.

FIG. 3 is a sequence chart showing a first operation example of the information processing apparatus according to Embodiment 1.

FIG. 4 is a sequence chart showing a second operation example of the information processing apparatus according to Embodiment 1.

FIG. 5 is a block diagram showing components of an information processing apparatus according to Embodiment 2, which are provided as functions of the printing control program.

FIG. 6 is a sequence chart showing a first operation example of the information processing apparatus according to Embodiment 2.

FIG. 7A is a sequence chart showing a second operation example of the information processing apparatus according to Embodiment 2.

FIG. 7B is a sequence chart showing the second operation example of the information processing apparatus according to Embodiment 2.

### DESCRIPTION OF EMBODIMENTS

Hereinafter, embodiments and the like will be described with reference to drawings. For clarification of description, the following description and drawings will be omitted and simplified as appropriate. Further, in the drawings, the same reference numerals are assigned to the same elements, and a redundant description is omitted as necessary. Further, in order to describe exemplary embodiments, not all features or steps shown in any one figure are necessarily required, and a part of the features or steps may be omitted. Furthermore, an order of steps described in any figure may be changed as appropriate.

### Embodiment 1

An information processing apparatus according to the present embodiment is connected to a printer, and can instruct the printer to print. The information processing apparatus configures a printing system, together with the printer.

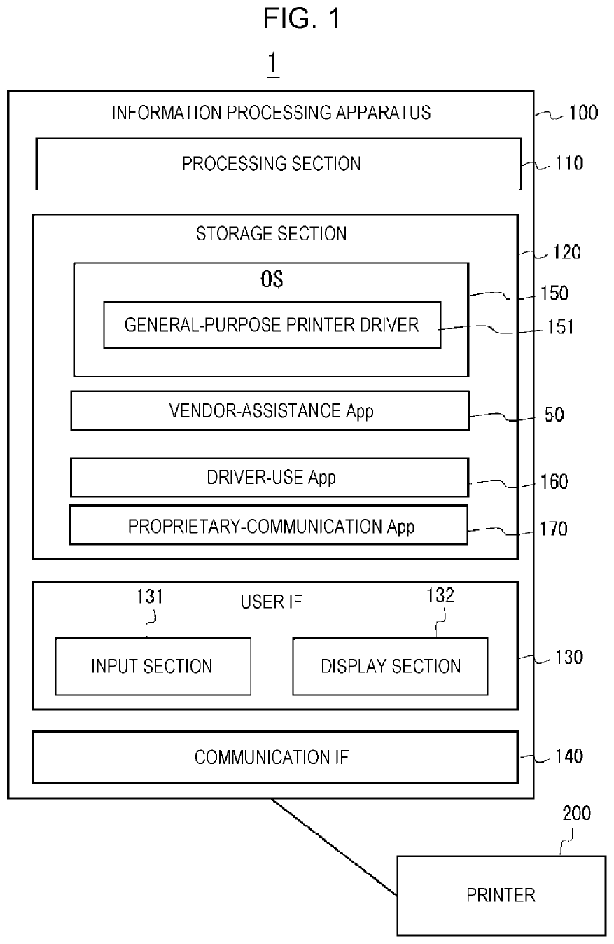

Hereinafter, a configuration example of the printing system including the information processing apparatus according to the present embodiment will be described with reference to FIG. 1. FIG. 1 is a block diagram showing the configuration example of the printing system according to the present embodiment.

As shown in FIG. 1, a printing system 1 according to the present embodiment includes an information processing apparatus 100 and a printer 200. FIG. 1 shows one printer 200, but the printing system 1 may include a plurality of printers 200. Further, the printing system 1 may include a plurality of information processing apparatuses 100.

The information processing apparatus 100 is a terminal apparatus having a communication function, such as a personal computer (PC), a smartphone, or a tablet-type terminal, and is used by a user who desires printing. The information processing apparatus 100 is connected to the printer 200 for performing processing of transmitting print data, and the like. In the present embodiment, the information processing apparatus 100 and the printer 200 are connected by a universal serial bus (USB) as an example, but may be connected according to another communication standard.

When the print data is received, the printer 200 executes printing processing in accordance with the print data. Accordingly, the printer 200 performs the printing in accordance with the print data on a medium such as paper. The printer 200 may also be referred to as a printing apparatus, an image forming apparatus, or a multifunction peripheral. The printer 200 may be an apparatus having the communication function and a printing function, and may be a multifunction peripheral having other functions such as a scan function, a copy function, and a facsimile function. The copy function is realized by the scan function and the printing function. Further, a printing method in the printer 200 is not limited, and various printing methods such as an ink jet printing method and a laser printing method can be applied.

The printer 200 has one or more communication interfaces for communicating with the information processing apparatus 100. In the present embodiment, the communication interface is specifically a USB interface. The printer 200 may have a plurality of USB interfaces.

Hereinafter, a configuration example of the information processing apparatus 100 will be described in detail.

As shown in FIG. 1, the information processing apparatus 100 includes, as main hardware configurations, a processing section 110, a storage section 120, a user interface (IF) 130, and a communication interface (IF) 140. The user IF 130 includes an input section 131 and a display section 132. The processing section 110, the storage section 120, the user IF 130, and the communication IF 140 may be mutually coupled via a data bus or the like. As will be described below, the information processing apparatus 100 has a function as a computer. The information processing apparatus 100 is a computer on which an operating system (OS) 150, a general-purpose printer driver 151, and a vendor-assistance application program 50, which will be described below, are installed. Further, in particular, a driver-use application program 160 and a proprietary-communication application program 170, which will be described below, are also installed in the information processing apparatus 100 in the present embodiment.

The processing section 110 is, for example, a processor such as a central processing unit (CPU), a micro-processing unit (MPU), and an application-specific integrated circuit (ASIC). The processing section 110 includes one or more processors. The processing section 110 has a function as a calculation device that performs control processing, calculation processing, and the like. The processing section 110 controls the storage section 120, the user IF 130, and the communication IF 140.

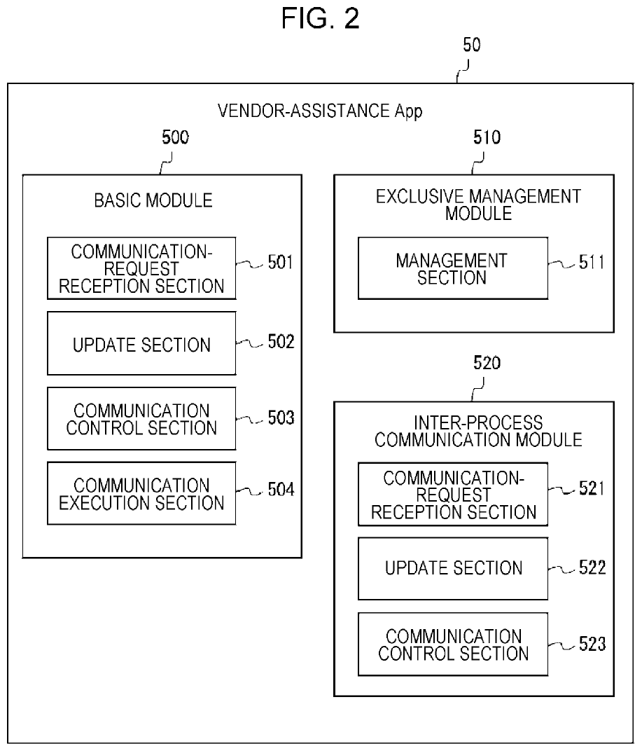

The storage section 120 is a storage device configured of one or more memories or storages, or a combination thereof. The memory is configured of a volatile memory or a nonvolatile memory, or a combination thereof. The volatile memory may be, for example, a random access memory (RAM). The nonvolatile memory may be, for example, a read-only memory (ROM). The storage may be a flash memory, a hard disk drive (HDD), or a solid-state drive (SSD). The storage section 120 has a function of storing a control program, a calculation program, and the like, which are executed by the processing section 110. Further, the storage section 120 has a function of temporarily storing processing data and the like. The processing section 110 (that is, a processor) reads out various programs from the storage section 120 (that is, a memory) and executes the various programs. Accordingly, in the present embodiment, the processing section 110 particularly realizes functions of the vendor-assistance application program 50, which will be described with reference to FIG. 2. Any function of the information processing apparatus 100, including the functions shown in FIG. 2 described below, may be realized not only by software using a program but also by any combination of hardware, firmware, and software, or the like. Further, each component may be realized by using, for example, a user-programmable integrated circuit such as a field-programmable gate array (FPGA) or a microcomputer. In this case, with the use of this integrated circuit, a program configured with components may be realized.

The communication IF 140 is an interface for the information processing apparatus 100 to communicate with another apparatus. The communication IF 140 may include a communication circuit and the like. In the present embodiment, the communication IF 140 includes the USB interface that is communicatively connected to the printer 200.

The user IF 130 includes the input section 131 that is an input device such as a keyboard or a pointing device. The user operates the input section 131 to input information to the information processing apparatus 100. For example, with the operation of the input section 131, the user can input, to the information processing apparatus 100, an instruction to set the printing, an instruction to execute the printing, and the like.

Further, the user IF 130 includes the display section 132 that displays the information. The display section 132 is, for example, a flat-panel display such as a liquid-crystal display, a plasma display, or an organic electro-luminescence (EL) display.

The input section 131 and the display section 132 may be configured as a physically integrated device such as a touch screen or a touch panel.

In the present embodiment, the information processing apparatus 100 includes the operating system (OS) 150, as the program read out from the storage section 120 and executed by the processing section 110. The OS 150 is basic software that controls an operation of the information processing apparatus 100. The OS 150 may be, for example, Windows (registered trademark), but the present disclosure is not limited thereto. In the following description, an example in which the OS 150 is Windows will be described as appropriate.

Further, in the present embodiment, the information processing apparatus 100 includes the driver-use application program 160 and the proprietary-communication application program 170, as the programs read out from the storage section 120 and executed by the processing section 110. In FIG. 1 and the following description, the driver-use application program is abbreviated as a driver-use App, and the proprietary-communication application program is abbreviated as a proprietary-communication App.

The driver-use App refers to an application that uses the general-purpose printer driver 151 described below. The driver-use App 160 can also be described as an application program communicating with the printer 200 via the general-purpose printer driver 151. The driver-use App 160 is, for example, document editing software, spreadsheet software, image editing software, or photo display software, but is not limited thereto. Further, the proprietary-communication App 170 refers to an application that does not use the general-purpose printer driver 151. The proprietary-communication App 170 can also be described as an application program communicating with the printer 200 without going through the general-purpose printer driver 151. Specific examples of the proprietary-communication App 170 include a raster image processor (RIP) application developed by a vendor of the printer 200, but the present disclosure is not limited thereto. Both the driver-use App 160 and the proprietary-communication App 170 are applications that request the communication with the printer 200 (specifically, USB communication in the present embodiment) for any processing. For this reason, when exclusive control of the communication is not appropriately performed, a collision in communication may occur, which may cause a malfunction of the application or the printer 200.

Further, in the present embodiment, the information processing apparatus 100 includes the general-purpose printer driver 151 and the vendor-assistance application program 50, as the programs read out from the storage section 120 and executed by the processing section 110. The general-purpose printer driver 151 may be a part of the OS 150. In FIG. 1 and in the following description, the vendor-assistance application program is abbreviated as a vendor-assistance App.

The general-purpose printer driver 151 will be described. The general-purpose printer driver 151 is an OS-standard printer driver that is included in the OS 150 or attached to the OS 150. That is, the general-purpose printer driver 151 is different from a printer driver developed and supplied by a vendor, who provides a printer. The general-purpose printer driver 151 is a program that can control, for various types of printers, a printer to execute the printing. That is, the general-purpose printer driver 151 is not for a specific printer, but is for various printers provided by various vendors. The general-purpose printer driver 151 can also be referred to as an OS general-purpose printing program or a general-purpose printing program.

The general-purpose printer driver 151 uses general-purpose protocols for searching for a printer and for performing printing. The general-purpose printer driver 151 uses, for example, mDNS/DNS-SD to search for a printer and uses IPP to perform printing on a printer. Here, DNS is an abbreviation of Domain Name System. mDNS is an abbreviation of multicast DNS. DNS-SD is an abbreviation of DNS Service Discovery. IPP is an abbreviation of Internet Printing Protocol. Thus, the general-purpose printer driver 151 can also be described as an OS-standard IPP class driver. IPP is an example of a standard protocol for controlling printer management and printing. In IPP, information acquisition and control of a printer are performed by Hyper Text Transfer Protocol (HTTP) POST requests and responses. In IPP, printer setting and printer state acquisition can be performed. Here, secure communication can be achieved by using HTTP Secure (HTTPS), instead of HTTP.

The vendor-assistance App 50 will be described. The vendor-assistance App 50 is an application program that assists the general-purpose printer driver 151, and is used to extend functions of the general-purpose printer driver 151. Thus, the general-purpose printer driver 151 can have a function of activating the vendor-assistance App 50 and a function of transmitting and receiving information to and from the vendor-assistance App 50. Specifically, the vendor-assistance App 50 is, for example, a print support application (PSA).

The vendor-assistance App 50 can be a program that assists the general-purpose printer driver 151 to cause a computer to execute printing control suitable for performance of a target printer, that is, printing control of supporting functions unique to the printer. The computer used here is the information processing apparatus 100 or the processing section 110 in the present embodiment.

The vendor-assistance App 50 is an application program provided by a printer vendor or the like. That is, the vendor-assistance App 50 is, for example, an application program developed by a vendor of the printer 200. The vendor-assistance App 50 can be provided to the user of the information processing apparatus 100 by being published, for example, in an application store or the like of an OS provider. Alternatively, the vendor-assistance App 50 can be provided to the user by being included in the OS or by being attached to the OS. The vendor-assistance App 50 may be activated from the general-purpose printer driver 151, or may be activated without going through the general-purpose printer driver 151.

In the present embodiment, the vendor-assistance App 50 includes a printing control program described next. That is, the printing control program can also be implemented as the PSA, for example. The printing control program is for extending the general-purpose printer driver 151 and for causing the computer (that is, the information processing apparatus 100) to have the functions shown in FIG. 2.

FIG. 2 is a block diagram showing components of the information processing apparatus 100 according to Embodiment 1, which are provided as the functions of the vendor-assistance App 50 (printing control program). As shown in FIG. 2, the information processing apparatus 100 has, as the functions of the vendor-assistance App 50, a communication-request reception section 501, an update section 502, a communication control section 503, a communication execution section 504, a management section 511, a communication-request reception section 521, an update section 522, and a communication control section 523. That is, the vendor-assistance App 50 (printing control program) causes the information processing apparatus 100 (computer) to execute processing of the communication-request reception section 501, the update section 502, the communication control section 503, the communication execution section 504, the management section 511, the communication-request reception section 521, the update section 522, and the communication control section 523. In other words, with the execution of the printing control program by the processing section 110 of the information processing apparatus 100, the processing of the communication-request reception section 501, the update section 502, the communication control section 503, the communication execution section 504, the management section 511, the communication-request reception section 521, the update section 522, and the communication control section 523 is executed.

In the example shown in FIG. 2, the communication-request reception section 501, the update section 502, the communication control section 503, and the communication execution section 504 are implemented as components of a basic module 500. Similarly, the management section 511 is implemented as a component of an exclusive management module 510, and the communication-request reception section 521, the update section 522, and the communication control section 523 are implemented as components of an inter-process communication module 520. As described above, the vendor-assistance App 50 may be configured of several modules. For convenience of description, in the present embodiment, the functions of the vendor-assistance App 50 will be described by dividing the functions into the communication-request reception section 501, the update section 502, the communication control section 503, the communication execution section 504, the management section 511, the communication-request reception section 521, the update section 522, and the communication control section 523. However, the functions of the vendor-assistance App 50 may not necessarily be divided as shown in FIG. 2. Further, a correspondence relationship between each of the communication-request reception section 501, the update section 502, the communication control section 503, the communication execution section 504, the management section 511, the communication-request reception section 521, the update section 522, and the communication control section 523 and the modules is not limited to the correspondence relationship shown in FIG. 2. Further, the functions of the vendor-assistance App 50 may not necessarily be implemented as the modules.

Hereinafter, the basic module 500 (the communication-request reception section 501, the update section 502, the communication control section 503, and the communication execution section 504), the exclusive management module 510 (the management section 511), and the inter-process communication module 520 (the communication-request reception section 521, the update section 522, and the communication control section 523) will be described in detail.

First, the management section 511 of the exclusive management module 510 will be described. The management section 511 manages whether or not the information processing apparatus 100 is in communication with the printer 200. Specifically, the management section 511 uses a flag indicating that the information processing apparatus 100 is in communication with the printer 200 to manage whether or not the information processing apparatus 100 is in communication with the printer 200. This flag is a variable indicating that the information processing apparatus 100 is in communication with the printer 200 when the flag is set to an enabled state. This flag can also be said to be a variable indicating whether or not a communication path between the information processing apparatus 100 and the printer 200 is in use. When the flag is enabled, the enabled flag indicates that the information processing apparatus 100 is in communication with the printer 200, that is, the communication path between the information processing apparatus 100 and the printer 200 is in use. On the contrary, when the flag is disabled, the disabled flag indicates that the information processing apparatus 100 is not in communication with the printer 200, that is, the communication path between the information processing apparatus 100 and the printer 200 is not in use. The management section 511 uses a flag different for each communication destination apparatus of the information processing apparatus 100. Further, when the communication destination apparatus may include a plurality of communication interfaces, the management section 511 uses a flag provided for each communication interface. That is, the management section 511 manages whether or not the information processing apparatus 100 is in communication, for each communication destination printer and for each communication interface. The management section 511 stores the flag in, for example, the storage section 120 (memory) to manage a state of the flag (that is, enabled or disabled). The fact that the flag is enabled can also be described as the flag being ON. Similarly, the fact that the flag is disabled can be described as the flag being OFF.

The management section 511 changes the flag in the disabled state to the enabled state, in response to a request from the update section 502 or the update section 522, which will be described below. In the present embodiment, the management section 511 receives an update request from the update section 502 or the update section 522. The update request includes information for specifying a communication destination (hereinafter referred to as communication destination specification information). The communication destination specification information includes at least information for identifying the communication destination apparatus. That is, the communication destination specification information includes identification information of the printer 200, which is a communication partner. Further, the communication destination specification information may include interface information for specifying which communication interface of the communication destination apparatus is used for communication. For example, when the printer 200 has a plurality of USB interfaces, the interface information specifies which of the USB interfaces is used to communicate with the printer 200.

When the update request for issuing an instruction for enabling is received, the management section 511 performs the following processing. When the flag corresponding to the received communication destination specification information is in the disabled state, the management section 511 changes the state of the flag to the enabled state. The management section 511 outputs a response indicating update success. On the contrary, when the update request for issuing the instruction for enabling of the flag, which is already in the enabled state, is received, that is, when the flag corresponding to the received communication destination specification information is already in the enabled state, the management section 511 outputs a response indicating update failure. That is, when the communication path corresponding to the communication destination specification information is already in use, the management section 511 outputs the response indicating the update failure. The update request for issuing the instruction for enabling is also referred to as a flag-ON request.

Further, when the update request for issuing an instruction for disabling is received, the management section 511 changes the flag in the enabled state to the disabled state. The update request for issuing the instruction for disabling is also referred to as a flag-OFF request.

Next, the communication-request reception section 501, the update section 502, the communication control section 503, and the communication execution section 504 of the basic module 500 will be described.

The communication-request reception section 501 receives a communication request to the printer 200 from the driver-use App 160. The communication request is a signal for requesting communication with the printer 200. More specifically, the communication-request reception section 501 receives the communication request to the printer 200 from the driver-use App 160 via the general-purpose printer driver 151, as shown in a sequence chart described below. The communication request is, for example, communication for requesting the printing by the printer 200, but the communication request received by the communication-request reception section 501 may be any communication request for requesting communication with the printer 200. The communication request includes the communication destination specification information. Further, the communication request may include other pieces of information. For example, the communication request for requesting the printing by the printer 200 may include the print data transmitted to the printer 200. That is, the communication-request reception section 501 may receive the print data. The processing of the communication-request reception section 501 may be referred to as reception processing.

The update section 502 updates the state of the flag, which is managed by the management section 511 of the exclusive management module 510 described above. The update section 502 performs update processing of enabling the above flag, in response to the reception by the communication-request reception section 501, that is, in response to the reception processing in the communication-request reception section 501. The update processing is processing of updating the flag that is in the disabled state, which is managed by the management section 511, to the enabled state. Specifically, the update section 502 transmits, to the management section 511, the update request including the communication destination specification information, which is included in the communication request received by the communication-request reception section 501. As described above, when the communication path corresponding to the communication request is not in use, the update of the flag is successful, but when the communication path corresponding to the communication request is already in use, the update of the flag fails.

Further, when executed communication is ended, the update section 502 disables the flag corresponding to the communication. That is, the update section 502 disables the flag that is enabled by the update section 502 at a time of communication start. For example, when the printing of the print data by the printer 200 is completed, the update section 502 disables the flag corresponding to the communication executed for the printing. The update section 502 performs the update processing of disabling the flag, in response to reception of a notification of printing completion from the printer 200, for example. The update processing is processing of updating the flag that is in the enabled state, which is managed by the management section 511, to the disabled state, that is, processing of returning the flag to the disabled state. Specifically, the update section 502 transmits, to the management section 511, the update request including the communication destination specification information corresponding to the ended communication. Accordingly, other applications can communicate with the printer 200.

The communication control section 503 controls the communication such that the collision in communication does not occur. That is, the communication control section 503 performs exclusive control of communication. The communication control section 503 particularly controls the communication for the communication request to the printer 200 from the driver-use App 160. In the present embodiment, the communication control section 503 determines whether to permit or prohibit the communication in accordance with an update result of the flag. When the update of the flag for the communication request received by the communication-request reception section 501 is successful, the communication control section 503 permits the execution of the communication requested by the communication request. On the contrary, when the update of the flag for the communication request received by the communication-request reception section 501 fails, the communication control section 503 prohibits the execution of the communication requested by the communication request. For example, when the state of the flag is already updated to the enabled state by the communication request from the proprietary-communication App 170 to the printer 200, the update section 502 fails to update the flag for the communication request to the printer 200 from the driver-use App 160. Thus, the communication control section 503 prohibits the communication requested by the communication request from the driver-use App 160. That is, when the flag corresponding to the communication request from the driver-use App 160 is already in the enabled state, the communication control section 503 prohibits the communication with the printer in accordance with the communication request. The processing of prohibiting the communication by the communication control section 503 and processing of prohibiting the communication by the communication control section 523 described below may be referred to as prohibition processing. The prohibition processing may be processing of waiting for the execution of the communication until the flag corresponding to the communication request is set to the disabled state. That is, the prohibition processing may be processing of waiting for the execution of the communication until the update of the flag is successful. In this case, the update section 502 may repeat the update processing of the flag at a predetermined time interval until the update of the flag is successful. Further, when the prohibition processing is performed, the communication control section 503 may output an error indicating that the communication is not permitted.

The communication execution section 504 executes the communication with the printer 200. The communication execution section 504 executes the communication requested by the received communication request. For example, when the communication request is communication for requesting the printing by the printer 200, the communication execution section 504 performs transmission processing of transmitting the received print data to the printer 200. However, the communication execution section 504 executes the communication only when the execution of the communication is permitted. For example, when the communication control section 503 permits the communication for the communication request from the driver-use App 160, the communication execution section 504 executes the communication requested by the communication request. Further, in the present embodiment, the communication execution section 504 may also execute the communication requested by the communication request from the proprietary-communication App 170. Therefore, when the communication control section 523 of the inter-process communication module 520 described below permits the communication for the communication request from the proprietary-communication App 170, the communication execution section 504 executes the communication requested by the communication request.

Next, the communication-request reception section 521, the update section 522, and the communication control section 523 of the inter-process communication module 520 will be described.

The communication-request reception section 521 receives the communication request to the printer 200 from the proprietary-communication App 170. In particular, the communication-request reception section 521 provides an inter-process communication service. Therefore, the inter-process communication module 520 can be said to be a module that provides the inter-process communication service. As described above, in the present embodiment, the proprietary-communication App 170, which is an application communicating with the printer 200 without using the general-purpose printer driver 151, communicates with the printer 200 via the inter-process communication service provided by the vendor-assistance App 50. In the present embodiment, the proprietary-communication App 170 is set in advance to transmit the communication request to the inter-process communication service (communication-request reception section 521) provided by the vendor-assistance App 50. The driver-use App 160, which is an application using the general-purpose printer driver 151, can directly use the functions of the vendor-assistance App 50, which is an application assisting the general-purpose printer driver 151. On the contrary, the proprietary-communication App 170, which is an application not using the general-purpose printer driver 151, cannot directly use the functions of the vendor-assistance App 50. Thus, in the present embodiment, the vendor-assistance App 50 provides inter-process communication for receiving the communication request of the proprietary-communication App 170. Accordingly, the proprietary-communication App 170 uses the exclusive control of the communication provided by the vendor-assistance App 50, via the inter-process communication.

The communication request received by the communication-request reception section 521 is, for example, communication for requesting the printing by the printer 200, but the communication request received by the communication-request reception section 521 may be any communication request for requesting the communication with the printer 200. The communication request received by the communication-request reception section 521 also includes the communication destination specification information. The communication request received by the communication-request reception section 521 may also include other pieces of information. For example, the communication request for requesting the printing by the printer 200 may include the print data transmitted to the printer 200. That is, the communication-request reception section 521 may receive the print data. The processing of the communication-request reception section 521 may be referred to as the reception processing. As described above, in the reception processing of the communication-request reception section 521, the reception of the communication request (print data) from the proprietary-communication App 170, which does not use the general-purpose printer driver 151, is performed by the inter-process communication.

The update section 522 updates the state of the flag, which is managed by the management section 511 of the exclusive management module 510, similarly to the update section 502. The update section 502 performs the update processing of the flag for the communication request from the driver-use App 160, whereas the update section 522 performs the update processing of the flag for the communication request from the proprietary-communication App 170. Therefore, the update section 522 performs the update processing of enabling the flag, in response to the reception by the communication-request reception section 521, that is, in response to the reception processing in the communication-request reception section 521. The processing of the update section 522 is different from the processing of the update section 502 only in that the communication request to be processed is the communication request from the proprietary-communication App 170, and thus a detailed description thereof will be omitted. In the update processing in the update section 522, the update of the flag is successful when the communication path corresponding to the communication request is not in use, but the update of the flag fails when the communication path corresponding to the communication request is already in use. When executed communication is ended, the update section 522 disables the flag corresponding to the communication, similarly to the update section 502. That is, the update section 522 disables the flag that is enabled by the update section 522 at a time of communication start.

The communication control section 523 also performs the exclusive control of communication, similarly to the communication control section 503. The communication control section 523 particularly controls the communication for the communication request to the printer 200 from the proprietary-communication App 170. The communication control section 523 determines whether to permit or prohibit the communication in accordance with an update result of the flag, similarly to the communication control section 503. The processing of the communication control section 523 is different from the processing of the communication control section 503 only in that the communication to be controlled is the communication requested by the communication request from the proprietary-communication App 170, and thus a detailed description thereof will be omitted. For example, when the state of the flag is already updated to the enabled state by the communication request to the printer 200 from the driver-use App 160, the update section 522 fails to update the flag for the communication request to the printer 200 from the proprietary-communication App 170. Thus, the communication control section 523 prohibits the communication requested by the communication request from the proprietary-communication App 170. That is, when the flag corresponding to the communication request from the proprietary-communication App 170 is already enabled, the communication control section 523 prohibits the communication with the printer in accordance with the communication request.

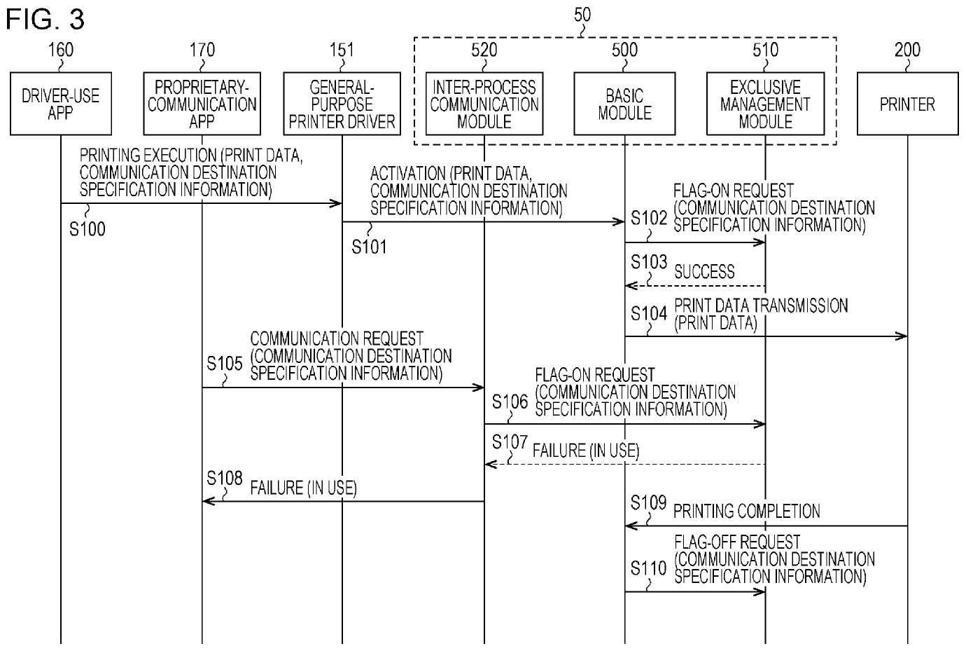

Next, an operation example of the information processing apparatus 100 according to the present embodiment will be described with reference to a sequence chart. FIG. 3 is a sequence chart showing a first operation example of the information processing apparatus 100 according to Embodiment 1. FIG. 3 shows an operation example of a case where the communication request by the driver-use App 160 is received first and the communication request by the proprietary-communication App 170 is received later. Hereinafter, the operation example will be described with reference to FIG. 3.

In step S100, the driver-use App 160 transmits the communication request to the general-purpose printer driver 151. In the example shown in FIG. 3, the driver-use App 160 transmits the communication request for executing the printing. This communication request includes the print data to be printed and the communication destination specification information. Next, in step S101, the general-purpose printer driver 151 activates the vendor-assistance App 50, and transmits the communication request (print data and communication destination specification information) received in step S100 to the vendor-assistance App 50. The communication-request reception section 501 of the basic module 500 receives the communication request. That is, the communication-request reception section 501 receives the print data together with the communication destination specification information.

Next, in step S102, the update section 502 of the basic module 500 transmits, to the management section 511 of the exclusive management module 510, the flag-ON request for issuing the instruction for enabling of the flag, which corresponds to the communication path specified by the communication destination specification information received in step S101. In the operation example shown in FIG. 3, since the flag is in the disabled state at this stage, the management section 511 enables the flag. In step S103, the management section 511 outputs the response indicating the update success. Meanwhile, since the update of the flag is successful, the communication control section 503 of the basic module 500 permits the communication requested by the communication request received in step S101. Thus, in step S104, the communication execution section 504 of the basic module 500 executes the communication with the printer 200. Specifically, the communication execution section 504 performs the processing of transmitting the print data to the printer 200. That is, the communication execution section 504 transmits the print data to a destination specified by the communication destination specification information included in the communication request received in step S101.

Thereafter, in step S105, the proprietary-communication App 170 transmits the communication request including the communication destination specification information to the inter-process communication module 520 of the vendor-assistance App 50. The communication request is, for example, the communication request for requesting the printing by the printer 200, but is not limited thereto. The communication-request reception section 521 of the inter-process communication module 520 receives the communication request. Next, in step S106, the update section 522 of the inter-process communication module 520 transmits, to the management section 511 of the exclusive management module 510, the flag-ON request for issuing the instruction for enabling of the flag, which corresponds to the communication path specified by the communication destination specification information received in step S105. However, since the flag is already enabled in step S102, the update of the flag fails. In step S107, the management section 511 outputs the response indicating the update failure, that is, the response indicating that the communication path is in use. Thus, the communication control section 523 of the inter-process communication module 520 prohibits the communication requested by the communication request received in step S105, and in step S108, the communication control section 523 transmits, to the proprietary-communication App 170, the error indicating that the communication is not permitted. As described above, since the execution of the communication by the communication request from the proprietary-communication App 170 is suppressed, the communication by the communication request from the proprietary-communication App 170 is prevented from being executed during the execution of the communication by the communication request from the driver-use App 160. That is, occurrence of the collision in communication can be avoided.

Thereafter, when the printing by the printer 200 is completed, in step S109, the communication execution section 504 of the basic module 500 receives the notification of printing completion from the printer 200. The notification from the printer 200 may include information for specifying a source of the notification (information for specifying the printer 200 and the communication interface of the printer 200). After step S109, in step S110, the update section 502 of the basic module 500 transmits, to the management section 511 of the exclusive management module 510, the flag-OFF request for issuing the instruction for disabling of the flag that is enabled in step S102. Meanwhile, the management section 511 disables the flag.

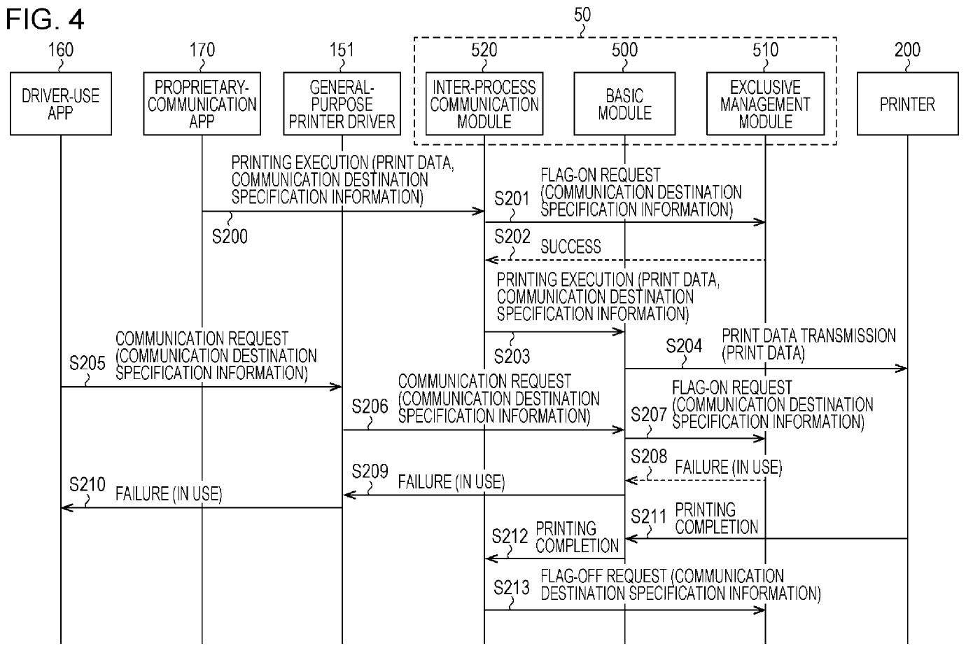

FIG. 4 is a sequence chart showing a second operation example of the information processing apparatus 100 according to Embodiment 1. FIG. 4 shows an operation example of a case where the communication request by the proprietary-communication App 170 is received first and the communication request by the driver-use App 160 is received later. Hereinafter, the operation example will be described with reference to FIG. 4.

In step S200, the proprietary-communication App 170 transmits the communication request to the inter-process communication module 520. The communication-request reception section 521 of the inter-process communication module 520 receives the communication request. When the proprietary-communication App 170 accesses the inter-process communication module 520, the proprietary-communication App 170 activates the vendor-assistance App 50 as the inter-process communication module to access the inter-process communication module 520. In the example shown in FIG. 4, the proprietary-communication App 170 transmits the communication request for executing the printing. This communication request includes the print data to be printed and the communication destination specification information.

Next, in step S201, the update section 522 of the inter-process communication module 520 transmits, to the management section 511 of the exclusive management module 510, the flag-ON request for issuing the instruction for enabling of the flag, which corresponds to the communication path specified by the communication destination specification information received in step S200. In the operation example shown in FIG. 4, since the flag is in the disabled state at this stage, the management section 511 enables the flag. In step S202, the management section 511 outputs the response indicating the update success. Meanwhile, since the update of the flag is successful, the communication control section 523 of the inter-process communication module 520 permits the communication requested by the communication request received in step S200. Thus, in step S203, the communication-request reception section 521 of the inter-process communication module 520 outputs the received communication request to the basic module 500. In step S204, the communication execution section 504 of the basic module 500 executes the communication with the printer 200 in accordance with the communication request. Specifically, the communication execution section 504 performs the processing of transmitting the print data to the printer 200. That is, the communication execution section 504 transmits the print data to a destination specified by the communication destination specification information included in the communication request received in step S200.

Thereafter, in step S205, the driver-use App 160 transmits the communication request including the communication destination specification information to the general-purpose printer driver 151. The communication request is, for example, the communication request for requesting the printing by the printer 200, but is not limited thereto. Next, in step S206, the general-purpose printer driver 151 transmits the communication request received in step S205 to the vendor-assistance App 50. The communication-request reception section 501 of the basic module 500 receives the communication request.

Next, in step S207, the update section 502 of the basic module 500 transmits, to the management section 511 of the exclusive management module 510, the flag-ON request for issuing the instruction for enabling of the flag, which corresponds to the communication path specified by the communication destination specification information received in step S206. However, since the flag is already enabled in step S201, the update of the flag fails. In step S208, the management section 511 outputs the response indicating the update failure, that is, the response indicating that the communication path is in use. Thus, the communication control section 503 of the basic module 500 prohibits the communication requested by the communication request received in step S206, and in step S209, the communication control section 503 transmits, to the general-purpose printer driver 151, the error indicating that the communication is not permitted. In step S210, the error is transmitted from the general-purpose printer driver 151 to the driver-use App 160. As described above, since the execution of the communication by the communication request from the driver-use App 160 is suppressed, the communication by the communication request from the driver-use App 160 is prevented from being executed during the execution of the communication by the communication request from the proprietary-communication App 170. That is, occurrence of the collision in communication can be avoided.

Thereafter, when the printing by the printer 200 is completed, in step S211, the communication execution section 504 of the basic module 500 receives the notification of printing completion from the printer 200. In step S212, the notification is output to the update section 522 of the inter-process communication module 520. In step S213, the update section 522 of the inter-process communication module 520 transmits, to the management section 511 of the exclusive management module 510, the flag-OFF request for issuing the instruction for disabling of the flag that is enabled in step S201. Meanwhile, the management section 511 disables the flag.

Embodiment 1 is described above. According to the above embodiment, the exclusive control of the communication is appropriately performed. Thus, even when the application communicating with the printer via the general-purpose printer driver and the application communicating with the printer without going through the general-purpose printer driver are installed in the information processing apparatus, the occurrence of the collision in communication can be avoided.

### Embodiment 2

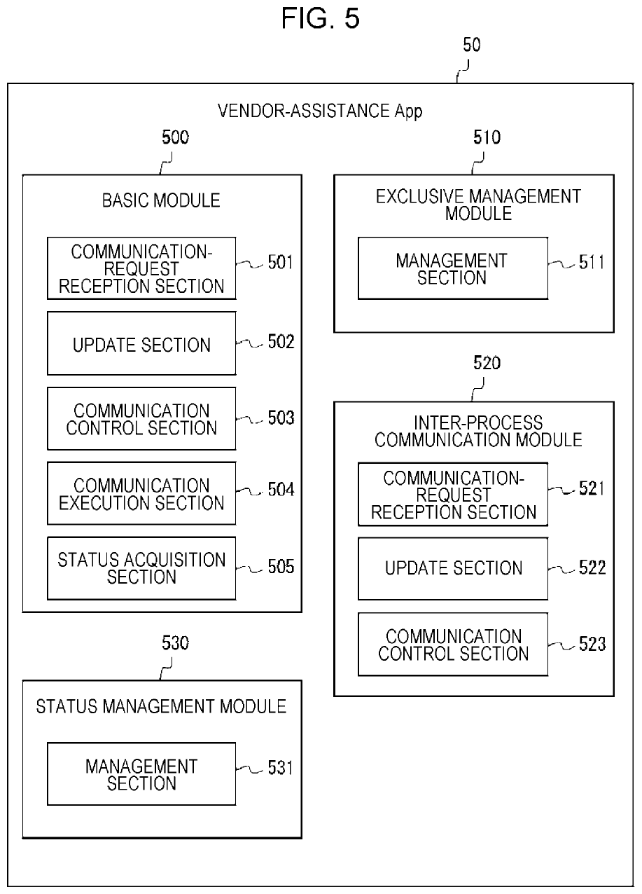

Next, Embodiment 2 will be described. In the present embodiment, the printing control program further includes functions to be described below, in addition to the functions described in Embodiment 1. As in Embodiment 1, in the present embodiment, the printing control program can also be implemented as the PSA, for example. In the present embodiment, the printing control program is for extending the general-purpose printer driver 151 and for causing the computer (that is, the information processing apparatus 100) to have the functions shown in FIG. 5. FIG. 5 is a block diagram showing components of the information processing apparatus 100 according to Embodiment 2, which are provided as functions of the printing control program.

As shown in FIG. 5, the information processing apparatus 100 according to Embodiment 2 is different from the information processing apparatus 100 according to Embodiment 1 in that a status acquisition section 505 and a management section 531 are further provided as functions of the vendor-assistance App 50 (printing control program). Therefore, in the present embodiment, the vendor-assistance App 50 (printing control program) further causes the information processing apparatus 100 (computer) to execute processing of the status acquisition section 505 and the management section 531. In other words, with the execution of the printing control program by the processing section 110 of the information processing apparatus 100, the processing of each component shown in FIG. 5 is executed.

In the example shown in FIG. 5, the communication-request reception section 501, the update section 502, the communication control section 503, the communication execution section 504, and the status acquisition section 505 are implemented as components of the basic module 500. Similarly, the management section 511 is implemented as the component of an exclusive management module 510, and the communication-request reception section 521, the update section 522, and the communication control section 523 are implemented as the components of the inter-process communication module 520. Further, the management section 531 is implemented as a component of a status management module 530. As described above, in the present embodiment, the vendor-assistance App 50 may also be configured of several modules. For convenience of description, in the present embodiment, the functions of the vendor-assistance App 50 will be described by dividing the functions into the respective components shown in FIG. 5, but the functions of the vendor-assistance App 50 may not be necessarily divided as shown in FIG. 5. Further, a correspondence relationship between each component and the modules shown in FIG. 5 is not limited to the correspondence relationship shown in FIG. 5. Further, the functions of the vendor-assistance App 50 shown in FIG. 5 may not necessarily be implemented as modules.

Hereinafter, details of Embodiment 2 will be described with omission of a description of the same configuration or processing as in Embodiment 1 as appropriate.

The management section 531 of the status management module 530 manages a status of the printer 200. The status of the printer 200 is any status of the printer 200, such as a remaining amount of consumables (for example, ink or paper) mounted on the printer 200 or an operation state of the printer 200. The management section 531 stores status information acquired by the status acquisition section 505 described below, for example, in the storage section 120 (memory) to manage the status of the printer 200. As described above, the management section 531 provides a cache function for the status information.

Further, the management section 531 responds with the status information of the printer 200, in response to a request from the communication control section 503 or the communication control section 523. In the present embodiment, the management section 531 receives a status request from the communication control section 503 or the communication control section 523. The status request includes the communication destination specification information. The management section 531 responds with the status information of the printer 200, which is specified by the communication destination specification information.

The status acquisition section 505 of the basic module 500 performs acquisition processing of acquiring, from the printer 200, the status information indicating the status of the printer 200 at a predetermined timing. Specifically, the predetermined timing is, for example, a timing immediately after the print data is transmitted to the printer 200. Since other communications are unlikely to occur immediately after the print data is transmitted, the status information of the printer 200 can be acquired without interfering with other communications. The status acquisition section 505 transmits the acquired status information to the management section 531 of the status management module 530, and instructs the management section 531 to cache the status information. Accordingly, the status information is cached by the management section 531.

The communication control section 503 or the communication control section 523 of the present embodiment is different from Embodiment 1 in that the communication control section 503 or the communication control section 523 operates as follows when the communication request for requesting the status of the printer 200 is generated from another application (second application) during execution of communication by the communication request from a certain application (first application). In the present embodiment, in this case, the communication control section 503 or the communication control section 523 performs transmission processing of transmitting, to the second application, the status information acquired in advance and cached, without stopping the communication between the first application and the printer 200. That is, the communication control section 503 or the communication control section 523 transmits the status information, which is managed by the management section 531, to the second application as the communication between the first application and the printer 200 is maintained. Accordingly, even when the communication path is in use by the first application, the second application can acquire the status information.

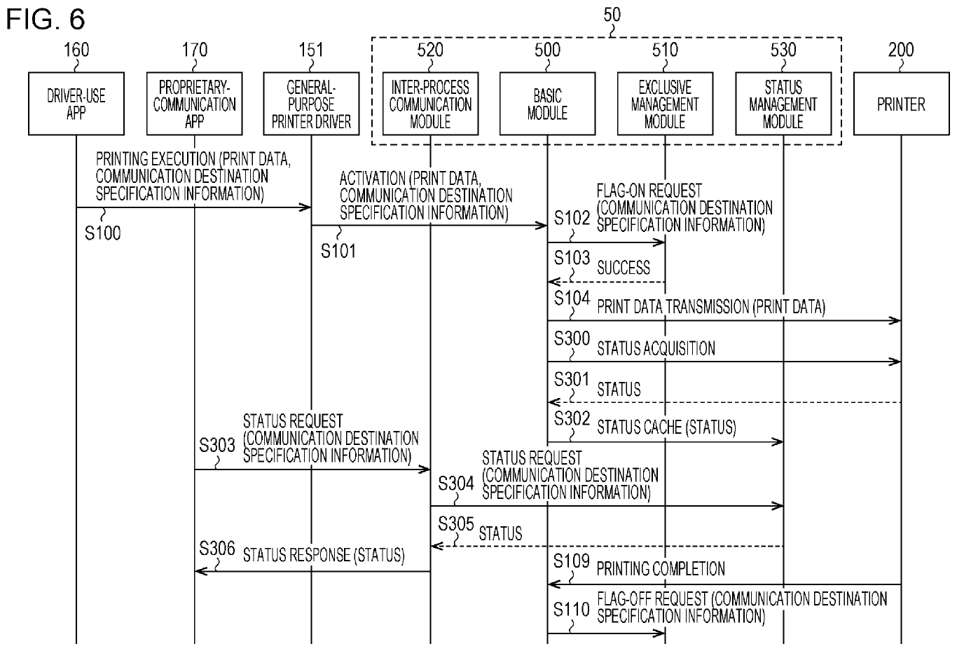

Next, an operation example of the information processing apparatus 100 according to the present embodiment will be described with reference to a sequence chart. FIG. 6 is a sequence chart showing a first operation example of the information processing apparatus 100 according to Embodiment 2. FIG. 6 shows an operation example of a case where the communication request by the driver-use App 160 is received first and the communication request by the proprietary-communication App 170 is received later. Further, the communication request by the proprietary-communication App 170 is a communication request for requesting the status from the printer 200.

The sequence chart shown in FIG. 6 is different from the sequence chart shown in FIG. 3 in that the processing of step S105 to step S108 is replaced with step S300 to step S306. Hereinafter, the first operation example of the information processing apparatus 100 according to Embodiment 2 will be described with omission of a description of the same processing as in the sequence chart shown in FIG. 3.

In the sequence chart shown in FIG. 6, processing of step S300 and step S301 is performed after step S104. In step S300 and step S301, the status acquisition section 505 of the basic module 500 acquires, from the printer 200, the status information indicating the status of the printer 200. Specifically, in the present embodiment, as an example, in step S300, the status acquisition section 505 causes the communication execution section 504 to transmit an acquisition request of the status for the printer 200. In step S301, the status acquisition section 505 acquires the status information, which is transmitted from the printer 200 in response to the acquisition request, via the reception processing of the communication execution section 504. Thereafter, in step S302, the status acquisition section 505 transmits the acquired status information to the management section 531 of the status management module 530, and instructs the management section 531 to cache the status information. Accordingly, the acquired status information is managed by the management section 531. As described above, as an example, the status acquisition section 505 acquires the status information of the printer 200 immediately after the print data is transmitted to the printer 200. Accordingly, the status information of the printer 200 can be acquired without interfering with other communications.

Then, in step S303, the proprietary-communication App 170 transmits the communication request including the communication destination specification information to the inter-process communication module 520 of the vendor-assistance App 50. In the present sequence chart, the communication request is a communication request for requesting the status from the printer 200. The communication-request reception section 521 of the inter-process communication module 520 receives the communication request. Next, in step S304, the communication control section 523 of the inter-process communication module 520 transmits the status request for reading out the status information of the printer 200, which is specified by the communication destination specification information, to the management section 531 of the status management module 530. Meanwhile, in step S305, the management section 531 responds with the status information of the printer 200, which is specified by the communication destination specification information. In step S306, the communication control section 523 of the inter-process communication module 520 transmits the status information to the proprietary-communication App 170. Accordingly, the proprietary-communication App 170 can check the status of the printer 200 even when the communication path for communicating with the printer 200 is in use by the driver-use App 160.

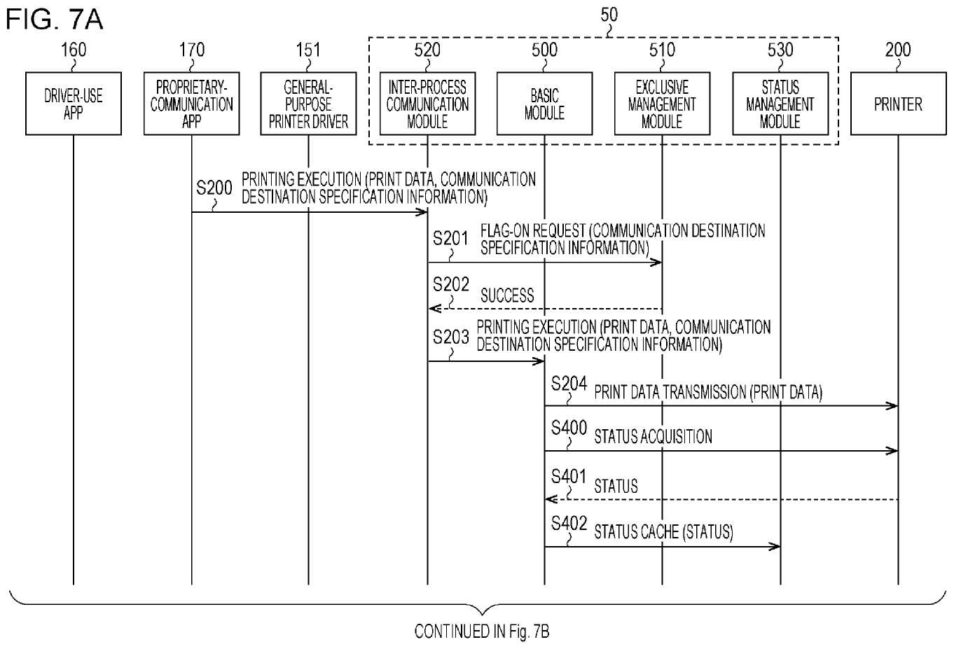

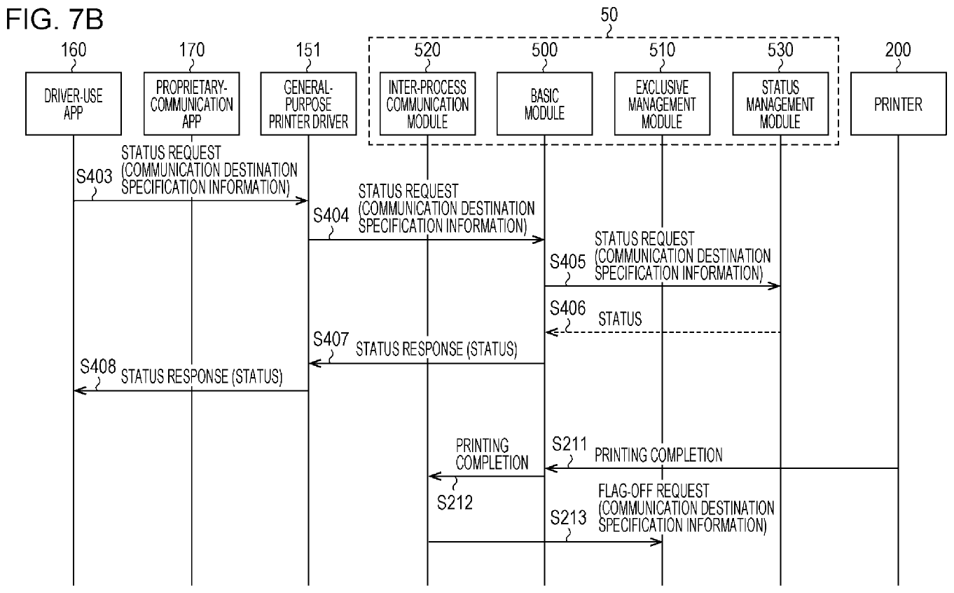

FIGS. 7A and 7B are sequence charts showing a second operation example of the information processing apparatus 100 according to Embodiment 2. FIGS. 7A and 7B show operation examples of a case where the communication request by the proprietary-communication App 170 is received first and the communication request by the driver-use App 160 is received later. Further, the communication request by the driver-use App 160 is a communication request for requesting the status from the printer 200.

The sequence charts shown in FIGS. 7A and 7B are different from the sequence chart shown in FIG. 4 in that the processing of step S205 to step S210 is replaced with step S400 to step S408. Hereinafter, the second operation example of the information processing apparatus 100 according to Embodiment 2 will be described with omission of a description of the same processing as in the sequence chart shown in FIG. 4.

In the sequence charts shown in FIGS. 7A and 7B, processing of step S400 and step S401 is performed after step S204. In step S400 and step S401, as in step S300 and step S301, the status acquisition section 505 of the basic module 500 acquires the status information indicating the status of the printer 200 from the printer 200. Thereafter, in step S402, the status acquisition section 505 transmits the acquired status information to the management section 531 of the status management module 530, and instructs the management section 531 to cache the status information. Accordingly, the acquired status information is managed by the management section 531.

Thereafter, in step S403, the driver-use App 160 transmits the communication request including the communication destination specification information to the general-purpose printer driver 151. In the present sequence chart, the communication request is a communication request for requesting the status from the printer 200. Next, in step S404, the general-purpose printer driver 151 transmits the communication request received in step S403 to the vendor-assistance App 50. The communication-request reception section 501 of the basic module 500 receives the communication request.

Next, in step S405, the communication control section 503 of the basic module 500 transmits the status request for reading out the status information of the printer 200, which is specified by the communication destination specification information, to the management section 531 of the status management module 530. Meanwhile, in step S406, the management section 531 responds with the status information of the printer 200, which is specified by the communication destination specification information. In step S407, the communication control section 503 of the basic module 500 transmits the status information to the general-purpose printer driver 151. In step S408, the general-purpose printer driver 151 transmits the status information to the driver-use App 160. Accordingly, the driver-use App 160 can check the status of the printer 200 even when the communication path for communicating with the printer 200 is in use by the proprietary-communication App 170.

Embodiment 2 is described above. According to Embodiment 2, even when the communication path with the printer 200 is in use, the status of the printer 200 can be acquired.

The present disclosure is not limited to the above embodiments, and can be changed as appropriate within a range without departing from the gist. For example, in the above embodiments, the exclusive control between the driver-use App 160 and the proprietary-communication App 170 is described, but the exclusive control between a plurality of driver-use Apps 160 or the exclusive control between a plurality of proprietary-communication Apps 170 may be performed.

Further, in the present disclosure, a program includes a group of commands (or software code) for causing a computer to perform one or more functions described in the embodiments when read by the computer. The program may be stored in a non-transitory computer-readable medium or a tangible storage medium. By way of non-limiting example, the computer-readable medium or the tangible storage medium includes a random-access memory (RAM), a read-only memory (ROM), a flash memory, a solid-state drive (SSD) or other memory technologies, a CD-ROM, a digital versatile disc (DVD), a Blu-ray (registered trademark) disc or other optical disc storages, a magnetic cassette, a magnetic tape, a magnetic disk storage or other magnetic storage devices. The program may be transmitted on a transitory computer-readable medium or on a communication medium. By way of non-limiting example, the transitory computer-readable medium or the communication medium includes electrical, optical, acoustic, or other forms of propagated signals. Further, the program is included in a computer program product.

Further, some or all of the above-described embodiments or modification examples may be described as the following supplementary notes, but are not limited to the following.

### Supplementary Note 1

A non-transitory computer-readable storage medium storing a printing control program that extends a general-purpose printer driver, the printing control program causing a computer to execute:
first reception processing of receiving print data from a first application;
first update processing of enabling a flag indicating that a printer is in communication in response to the reception in the first reception processing;
first transmission processing of transmitting the received print data to the printer;
second reception processing of receiving a communication request to the printer from a second application; and
prohibition processing of prohibiting, when the flag is enabled, the communication with the printer in response to the communication request from the second application, in which
the first application is any one of an application using the general-purpose printer driver and an application not using the general-purpose printer driver, and the second application is another one of the application using the general-purpose printer driver and the application not using the general-purpose printer driver.

### Supplementary Note 2

The non-transitory computer-readable storage medium storing a printing control program according to Supplementary Note 1, the printing control program causing the computer to further execute:
second update processing of disabling the flag when printing of the print data by the printer is completed.

### Supplementary Note 3

The non-transitory computer-readable storage medium storing a printing control program according to Supplementary Note 1 or 2, the printing control program causing the computer to further execute:
acquisition processing of acquiring, from the printer, status information indicating a status of the printer at a predetermined timing; and
second transmission processing of transmitting, when the communication request from the second application is a communication request for requesting the status of the printer, the status information acquired in advance by the acquisition processing to the second application without stopping communication between the first application and the printer.

### Supplementary Note 4

The non-transitory computer-readable storage medium storing a printing control program according to Supplementary Note 3, in which
the predetermined timing is immediately after the print data is transmitted to the printer.

### Supplementary Note 5

The non-transitory computer-readable storage medium storing a printing control program according to any one of Supplementary Notes 1 to 4, in which
the printing control program is a print support application.

### Supplementary Note 6

An information processing apparatus that includes a general-purpose printer driver and a printing control program extending the general-purpose printer driver, the information processing apparatus including:
as functions of the printing control program,
a first communication-request reception section that receives print data from a first application;
an update processing section that enables a flag indicating that a printer is in communication in response to the reception in the first communication-request reception section;
a communication execution section that transmits the received print data to the printer;
a second communication-request reception section that receives a communication request to the printer from a second application; and
a communication control section that prohibits, when the flag is enabled, the communication with the printer in response to the communication request from the second application, in which
the first application is any one of an application using the general-purpose printer driver and an application not using the general-purpose printer driver, and the second application is another one of the application using the general-purpose printer driver and the application not using the general-purpose printer driver.

### Supplementary Note 7

A control method executing, by a computer that includes a general-purpose printer driver and a printing control program extending the general-purpose printer driver, the printing control program to execute:
first reception processing of receiving print data from a first application;
first update processing of enabling a flag indicating that a printer is in communication in response to the reception in the first reception processing;
first transmission processing of transmitting the received print data to the printer;
second reception processing of receiving a communication request to the printer from a second application; and
prohibition processing of prohibiting, when the flag is enabled, the communication with the printer in response to the communication request from the second application, in which
the first application is any one of an application using the general-purpose printer driver and an application not using the general-purpose printer driver, and the second application is another one of the application using the general-purpose printer driver and the application not using the general-purpose printer driver.

What is claimed is:

1. A non-transitory computer-readable storage medium storing a printing control program that extends a general-purpose printer driver, the printing control program causing a computer to execute:
first reception processing of receiving print data from a first application;
first update processing of enabling a flag indicating that a printer is in communication in response to the reception in the first reception processing;
first transmission processing of transmitting the received print data to the printer;
second reception processing of receiving a communication request to the printer from a second application; and
prohibition processing of prohibiting, when the flag is enabled, the communication with the printer in response to the communication request from the second application, wherein
the first application is any one of an application using the general-purpose printer driver and an application not using the general-purpose printer driver, and the second application is another one of the application using the general-purpose printer driver and the application not using the general-purpose printer driver.

2. The non-transitory computer-readable storage medium storing a printing control program according to claim 1, the printing control program causing the computer to further execute:
second update processing of disabling the flag when printing of the print data by the printer is completed.

3. The non-transitory computer-readable storage medium storing a printing control program according to claim 1, the printing control program causing the computer to further execute:
acquisition processing of acquiring, from the printer, status information indicating a status of the printer at a predetermined timing; and
second transmission processing of transmitting, when the communication request from the second application is a communication request for requesting the status of the printer, the status information acquired in advance by the acquisition processing to the second application without stopping communication between the first application and the printer.

4. The non-transitory computer-readable storage medium storing a printing control program according to claim 3, wherein
the predetermined timing is immediately after the print data is transmitted to the printer.

5. The non-transitory computer-readable storage medium storing a printing control program according to claim 1, wherein
the printing control program is a print support application.

6. An information processing apparatus that includes a general-purpose printer driver and a printing control program extending the general-purpose printer driver, the information processing apparatus comprising:
as functions of the printing control program,
a first communication-request reception section that receives print data from a first application;
an update processing section that enables a flag indicating that a printer is in communication in response to the reception in the first communication-request reception section;
a communication execution section that transmits the received print data to the printer;
a second communication-request reception section that receives a communication request to the printer from a second application; and
a communication control section that prohibits, when the flag is enabled, the communication with the printer in response to the communication request from the second application, wherein
the first application is any one of an application using the general-purpose printer driver and an application not using the general-purpose printer driver, and the second application is another one of the application using the general-purpose printer driver and the application not using the general-purpose printer driver.

7. A control method executing, by a computer that includes a general-purpose printer driver and a printing control program extending the general-purpose printer driver, the printing control program to execute:
first reception processing of receiving print data from a first application;
first update processing of enabling a flag indicating that a printer is in communication in response to the reception in the first reception processing;
first transmission processing of transmitting the received print data to the printer;
second reception processing of receiving a communication request to the printer from a second application; and
prohibition processing of prohibiting, when the flag is enabled, the communication with the printer in response to the communication request from the second application, wherein
the first application is any one of an application using the general-purpose printer driver and an application not using the general-purpose printer driver, and the second application is another one of the application using the general-purpose printer driver and the application not using the general-purpose printer driver.
